(19) United States
(12) Patent Application Publication
(10) Pub. No.: US 2023/0336018 A1
(43) Pub. Date: Oct. 19, 2023

(54) Solar-Powered Charging Block Device

(71) Applicants: Starr Thomas, Philadelphia, PA (US); Stacy Thomas, Philadelphia, PA (US)

(72) Inventors: Starr Thomas, Philadelphia, PA (US); Stacy Thomas, Philadelphia, PA (US)

(21) Appl. No.: 18/299,851

(22) Filed: Apr. 13, 2023

Related U.S. Application Data
(60) Provisional application No. 63/330,991, filed on Apr. 14, 2022.

(51) Int. Cl. H02J 7/35; H02S 40/38; H02J 7/00

(52) U.S. Cl. CPC H02J 7/35; H02S 40/38; H02J 7/0048; H02J 7/0042

(57) ABSTRACT

The present invention relates to a solar-powered charging block device that converts light into electrical power via a solar panel. As a result, a user can use a charging cord plugged into a charging port of the device to charge a smart device. The device may also be comprised of an integrated, backup battery plug.

### CROSS-REFERENCE TO RELATED APPLICATION

The present application claims priority to, and the benefit of, U.S. Provisional Application No. 63/330,991, which was filed on Apr. 14, 2022, and is incorporated herein by reference in its entirety.

### FIELD OF THE INVENTION

The present invention relates generally to the field of charging devices. More specifically, the present invention relates to a solar-powered charging block device. The device converts light into electrical power via a solar panel, such that a user can use a charging cord plugged into a charging port of the device to charge a smart device. Accordingly, the present disclosure makes specific reference thereto. Nonetheless, it is to be appreciated that aspects of the present invention are also equally applicable to other like applications, devices, and methods of manufacture.

### BACKGROUND

In order to charge the battery of a smart device, such as a cellphone, tablet, laptop, etc., an individual must be near an electrical outlet and must plug the device into a charging block in the outlet via a cord for an extended length of time. If an electrical outlet is not available, the device cannot be charged, which is undesirable as the individual may miss important phone calls or text messages.

Therefore, there exists a long-felt need in the art for an improved smart device charging device. More specifically, there exists a long-felt need in the art for a solar-powered charging block device. In addition, there exists a long-felt need in the art for a solar-powered charging block device that can be used to recharge a smart device without the need for a wall outlet. Furthermore, there exists a long-felt need in the art for a solar-powered charging block device that can be used outdoors.

The subject matter disclosed and claimed herein, in one embodiment thereof, comprises a solar-powered charging block device. The device is primarily comprised of a body with at least one charging port, at least one solar panel, and at least one battery. During use, the solar panel absorbs light and converts said light into electrical power stored within a battery. A user can then plug a charging cord into a smart device and into the charging port to power the smart device from the battery of the device. The device may also be comprised of a foldable wall plug that also allows a user to charge the battery via a wall outlet.

In this manner, the solar-powered charging block device of the present invention accomplishes all the foregoing objectives and provides an improved smart device charging device. More specifically, the device can be used to recharge a smart device without the need for a wall outlet. Furthermore, the device can be used outdoors and can use sunlight to recharge a smart device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar-powered charging block device primarily comprised of a body with at least one charging port, at least one solar panel, and at least one battery. The charging port may be any USB port known in the art such as, but not limited to, USB-A, USB-B, Micro-B, Micro-USB, Mini-USB, USB-C, etc. In any embodiment, the port is preferably a female port.

The port receives a male charging port of a first end of a charging cord. The second end of the cord is also comprised of a male charging port that can be placed into the female charging port of a smart device (or other personal electronic device) to allow the user to charge the smart device via the device.

The solar panel is positioned on the outside surface of the body, such that it absorbs sunlight (or other artificial light) and converts said light into electrical energy stored within at least one battery of the device. The battery then provides power to the charging cord when the charging cord is plugged into the charging port to provide electrical power to charge a smart device or other personal electronic device.

In the preferred embodiment, the device is comprised of at least one battery indicator comprised of at least one LED. In this manner, a user can press at least one button on the device which will illuminate the corresponding number of indicators to allow a user to view the charge left on the battery.

The present invention is also comprised of a method of using the device. First, a device is provided primarily comprised of a body with at least one charging port, at least one solar panel, and at least one battery. Then, the device is exposed to sunlight to allow the solar panel to charge the battery. Next, a charging port of a first end of a charging cord can be plugged into the charging port and a second charging port of a second end of the charging cord can be plugged into a smart device to charge the smart device via the battery.

Accordingly, the solar-powered charging block device of the present invention is particularly advantageous as it provides an improved smart device charging device that can be used to recharge a smart device without the need for a wall outlet. Furthermore, the device can be used outdoors and can use sunlight to recharge a smart device. In this manner, the solar-powered charging block device overcomes the limitations of existing charging devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a solar-powered charging block device of the present invention in accordance with the disclosed architecture;

FIG. 2 illustrates a rear view of one potential embodiment of a solar-powered charging block device of the present invention in accordance with the disclosed architecture;

FIG. 3 illustrates a perspective view of one potential embodiment of a solar-powered charging block device of the present invention while being used to charge a smart device in accordance with the disclosed architecture; and

FIG. 4 illustrates a flowchart of a method of using one potential embodiment of a solar-powered charging block device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved smart device charging device. More specifically, there exists a long-felt need in the art for a solar-powered charging block device. In addition, there exists a long-felt need in the art for a solar-powered charging block device that can be used to recharge a smart device without the need for a wall outlet. Furthermore, there exists a long-felt need in the art for a solar-powered charging block device that can be used outdoors.

The present invention, in one exemplary embodiment, is comprised of a solar-powered charging block device. The device is primarily comprised of a body with at least one charging port, at least one solar panel, and at least one battery. The charging port may be any USB port known in the art such as, but not limited to, USB-A, USB-B, Micro-B, Micro-USB, Mini-USB, USB-C, etc. In any embodiment, the port is preferably a female port that receives a male charging port of a first end of a charging cord. The second end of the cord is also comprised of a male charging port that can be placed into the female charging port of a smart device (or other personal electronic device) to allow the user to charge the smart device via the device.

The solar panel is positioned on the outside surface of the body, such that it absorbs sunlight (or other artificial light) and converts said light into electrical energy stored within at least one battery of the device. The battery then provides power to the charging cord when the charging cord is plugged into the charging port to provide electrical power to charge a smart device or other personal electronic device.

In the preferred embodiment, the device is comprised of at least one battery indicator comprised of at least one LED. In this manner, a user can press at least one button on the device which will illuminate the corresponding amount of indicators to allow a user to view the charge left on the battery.

The present invention is also comprised of a method of using the device. First, a device is provided primarily comprised of a body with at least one charging port, at least one solar panel, and at least one battery. Then, the device is exposed to sunlight to allow the solar panel to charge the battery. Next, a charging port of a first end of a charging cord can be plugged into the charging port and a second charging port of a second end of the charging cord can be plugged into a smart device to charge the smart device via the battery.

Accordingly, the solar-powered charging block device of the present invention is particularly advantageous as it provides an improved smart device charging device that can be used to recharge a smart device without the need for a wall outlet. Furthermore, the device can be used outdoors and can use sunlight to recharge a smart device. In this manner, the solar-powered charging block device overcomes the limitations of existing charging devices known in the art.

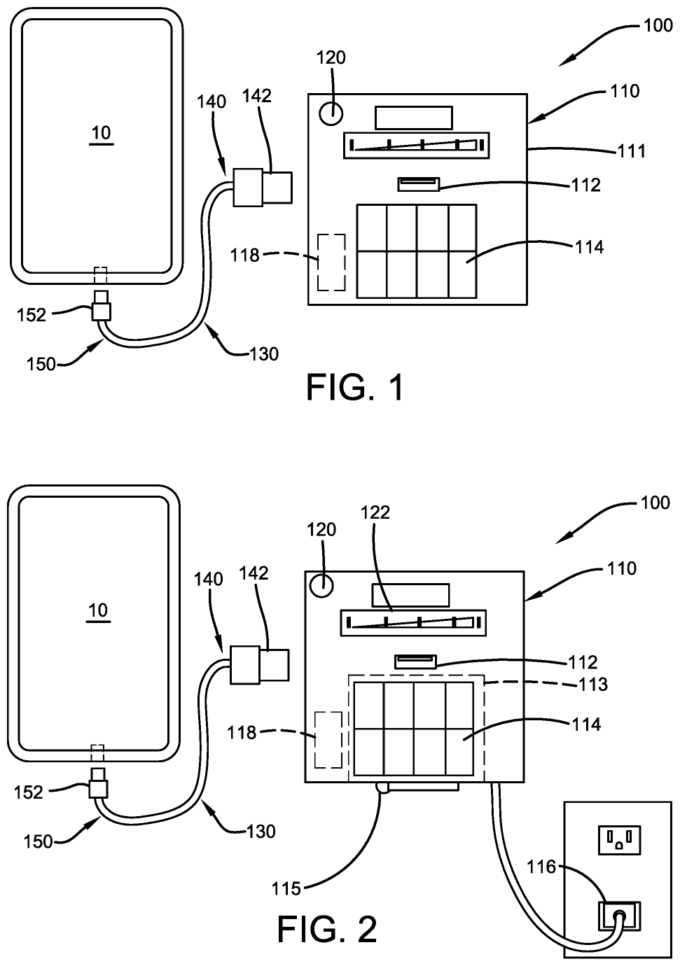

Referring initially to the drawings, FIG. 1 illustrates a front view of one potential embodiment of a solar-powered charging block device 100 of the present invention in accordance with the disclosed architecture. The device 100 is primarily comprised of a body 110 with at least one charging port 112, at least one solar panel 114, and at least one battery 118. The body 110 of the device 100 is preferably square but may be any shape and size in different embodiments. The body 110 is preferably made from a UV-resistant plastic material to protect the body 110 from sunlight damage while being used outdoors.

The body 110 preferably has at least one charging port 112. The port 112 may be any USB port known in the art such as, but not limited to, USB-A, USB-B, Micro-B, Micro-USB, Mini-USB, USB-C, etc. Alternatively, the port 112 may be any power charging port known in the art of charging any personal electronic device. In any embodiment, the port 112 is preferably a female port.

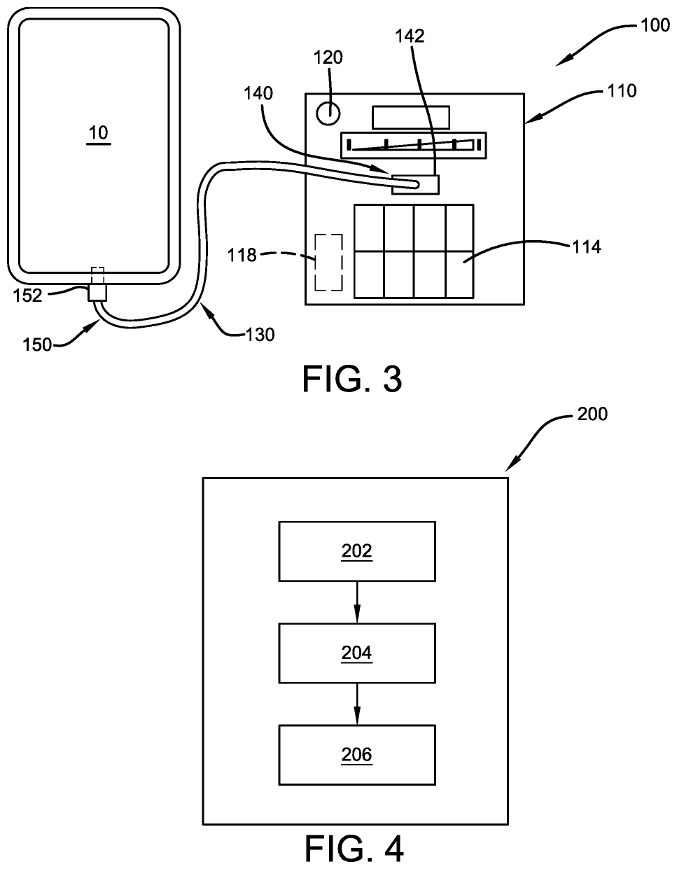

The port 112 then receives a male charging port 142 of a first end 140 of a charging cord 130. The second end 150 of the cord 130 is also comprised of a male charging port 152. This charging port 152 can be placed into the female charging port of a smart device 10 (or other personal electronic device) to allow the user to charge the smart device 10 via the device 100, as seen in FIG. 3. The ports 142,152 are preferably, but not limited to, any type of USB charging port known in the art.

More specifically, the body 110 is comprised of at least one solar panel 114 on the outside surface 111 of the body 110. The solar panel 114 may be any type known in the art such as, but not limited to, monocrystalline silicon, polycrystalline silicon, a photovoltaic cell film, etc. The solar panel 114 absorbs sunlight (or other artificial light) and converts said light into electrical energy stored within at least one battery 118 of the device 100. The battery 118 then provides power to the charging cord 130 when the charging cord 130 is plugged into the charging port 112 to provide electrical power to charge a smart device 10 or other personal electronic device.

In the preferred embodiment, the device 100 is comprised of at least one battery indicator 122. The indicator 122 is comprised of at least one LED, but is preferably comprised of a plurality of LEDs, which may represent specific battery percentages (i.e., 25%, 50%,75%, 100%). In this manner, a user can press at least one button 120 on the device 100 which will illuminate the corresponding number of indicators 122 to allow a user to view the charge left on the battery 118.

In one embodiment, the device 100 may be comprised of a backup charging mechanism for the battery 118 in the form of a wall plug 116, as seen in FIG. 2. The plug 116 is preferably a male 120V (or other voltage) plug known in the art. The plug 116 is attached to the body 110 via at least one hinge 115. When not in use, the plug 116 can be folded into at least one recessed area 113 of the body 110 such that the plug 116 does not protrude from the body 110.

It should be appreciated that in different embodiments, the device 100 may be designed to charge small smart devices 10 like cell phones and/or larger smart devices 100 such as tablets and laptops. As a result, the device 100 may be any voltage.

The present invention is also comprised of a method of using the device 100, as seen in FIG. 4. First, a device 100 is provided primarily comprised of a body 110 with at least one charging port 112, at least one solar panel 114, and at least one battery 118 [Step 202]. Then, the device 100 is exposed to sunlight to allow the solar panel 114 to charge the battery 118 [Step 204]. Next, a charging port 142 of a first end 140 of a charging cord 130 can be plugged into the charging port 112 and a second charging port 152 of a second end 150 of the charging cord 130 can be plugged into a smart device 10 to charge the smart device 10 via the battery 118 [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar-powered charging block device” and “device” are interchangeable and refer to the solar-powered charging block device 100 of the present invention.

Notwithstanding the foregoing, the solar-powered charging block device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the solar-powered charging block device 100 as shown in the FIGS. are for illustrative purposes only, and that many other sizes and shapes of the solar-powered charging block device 100 are well within the scope of the present disclosure. Although the dimensions of the solar-powered charging block device 100 are important design parameters for user convenience, the solar-powered charging block device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar-powered charging block device comprising:
a solar panel;
a battery;
a charging port;
a button; and
a battery indicator.

2. The solar-powered charging block device of claim 1, wherein the solar panel is comprised of a monocrystalline silicon, a polycrystalline silicon, or a photovoltaic cell film.

3. The solar-powered charging block device of claim 1, wherein the charging port is comprised of a USB-A, a USB-B, a Micro-B, a Micro-USB, a Mini-USB, or a USB-C port.

4. The solar-powered charging block device of claim 1, wherein the battery indicator is comprised of an LED light.

5. The solar-powered charging block device of claim 1, wherein the battery indicator displays a charge level of the battery.

6. The solar-powered charging block device of claim 1, wherein the button activates the battery indicator.

7. A solar-powered charging block device comprising:
a body;
a solar panel positioned on the body;
a battery;
a female charging port;
a wall plug;
a hinge;
a button; and
a battery indicator.

8. The solar-powered charging block device of claim 7, wherein the body is comprised of a UV-resistant plastic.

9. The solar-powered charging block device of claim 7, wherein the female charging port is comprised of a female USB-A, a female USB-B, a female Micro-B, a female Micro-USB, a female Mini-USB, or a female USB-C port.

10. The solar-powered charging block device of claim 7 further comprised of a charging cord.

11. The solar-powered charging block device of claim 10, wherein the charging cord is comprised of a first charging port and a second charging port.

12. The solar-powered charging block device of claim 11, wherein the first charging port is comprised of a male USB port.

13. The solar-powered charging block device of claim 11, wherein the second charging port is comprised of a male USB port.

14. The solar-powered charging block device of claim 7, wherein the battery indicator is comprised of a first LED light, a second LED light, a third LED light, and a fourth LED light.

15. The solar-powered charging block device of claim 7, wherein the body is comprised of a recessed area.

16. The solar-powered charging block device of claim 15, wherein the hinge is positioned within the recessed area.

17. The solar-powered charging block device of claim 16, wherein the wall plug attaches to the hinge.

18. The solar-powered charging block device of claim 7, wherein the wall plug is comprised of a male 120v wall plug.

19. A method of using a solar-powered charging block device, the method comprising the following steps:
providing a solar-powered charging block device comprised of a body with a charging port, a solar panel, and a battery;
exposing the solar panel to light to allow the solar panel to charge the battery; and
charging a smart device by plugging a charging cord into a charging port of the solar-powered charging block device and into the smart device.

20. The method of claim 19, wherein the smart device is comprised of a cellphone.
